(19) United States
(12) Patent Application Publication
(10) Pub. No.: US 2009/0214243 A1
(43) Pub. Date: Aug. 27, 2009

(54) Fixing Device and Image Forming Apparatus

(75) Inventors: Junya Yoda, Osaka (JP); Izumi Kadobayashi, Osaka (JP)

Correspondence Address: VON SIMSON & CHIN, 62 WILLIAM STREET, 6TH FLOOR, NEW YORK, NY, 10005, US

(73) Assignee: Kyocera Mita

(21) Appl. No.: 12/371,217

(22) Filed: Feb. 13, 2009

(30) Foreign Application Priority Data
Feb. 26, 2008 (JP) 2008-044677
Feb. 26, 2008 (JP) 2008-044687

(51) Int. Cl. G03G 15/20

(52) U.S. Cl. 399/69; 399/329; 399/328

(57) ABSTRACT

A fixing device has: (a) an electromagnetic coil placed with a gap from a member of a magnetic material to be heated; a switching device that supplies electronic power to the electromagnetic coil; (b) a switching control unit that controls duty ratio for the switching device under a condition that a load voltage and a load current of the switching device are substantially zero when the switching device is turned on and/or off; (c) a shield member capable of being placed between the electromagnetic coil and the member to be heated to shield the member to be heated against a magnetic flux from the electromagnetic coil; and (d) a shield control unit that controls a shield amount of the shield member by moving either the shield member or both the electromagnetic coil and the member to be heated.

### CROSS-REFERENCE TO RELATED APPLICATIONS

This application relates to and claims priority rights from Japanese Patent Applications:

No. 2008-044677, filed on Feb. 26th, 2008, and

No. 2008-044687, filed on Feb. 26th, 2008, the entire disclosures of which are hereby incorporated by reference herein.

### BACKGROUND OF THE INVENTION

1. Field of the Invention

This invention relates to a fixing device that heats a fixing roller by electromagnetic induction heating, and an image forming apparatus that has the fixing device.

2. Description of the Related Art

An image forming apparatus such as printer machine, copy machine, facsimile machine or multi function peripheral has a fixing device that heats a hollow fixing roller of a magnetic material by magnetic induction heating. Specifically, an electromagnetic coil is placed with a gap from the fixing roller. Conducting an AC current through the electromagnetic coil generates a magnetic flux through the fixing roller. Consequently, the magnetic flux induces an eddy current (i.e. an electromagnetic induction current) in the fixing roller, and the eddy current heats the fixing roller.

In general, an image forming apparatus contains such fixing roller, and controls temperature of the fixing roller by controlling a value of electronic power supplied to the electromagnetic coil according to a temperature value of the fixing roller detected by a temperature sensor. A PWM (Pulse Width Modulation) control can control a value of electronic power supplied to the electromagnetic coil by controlling duty ratio of a switching device (e.g. IGBT) that supplies electronic power to the electromagnetic coil on and off. The longer period the switching device is on, the more electronic power is supplied to the electromagnetic coil, but the longer period the switching device is off, the less electronic power is supplied to the electromagnetic coil.

As shown in FIG. 9A, zero cross switching is favorable in the PWM control. The zero cross switching turns on and off the switching device at the timing when both a load voltage and a load current of the switching device are substantially zero. Therefore, an electronic power loss, overheat and malfunction at the switching device tend not to occur.

When low electronic power is supplied to the electromagnetic coil under high temperature of the fixing roller, too short a period that the switching device is on in the PWM control vanishes the timing when the voltage and the current are zero. As a result, the zero cross switching can not be performed. To solve this problem, when low electronic power is supplied to the electromagnetic coil, a technique fixes length of a period that the switching device is on, and controls length of a period that the switching device is off in order to reduce an electronic power loss at the switching device. Specifically, the length of the period that the switching device is on is fixed as a predetermined minimum value capable of the zero cross switching, and a long period that the switching device is off is set as necessary.

### SUMMARY OF THE INVENTION

However, the aforementioned technique may not perform the zero cross switching when the switching device is turned on, and may cause a large electronic power loss at the switching device. In addition, a restart of switching operation for the switching device causes a large ripple and a flicker. The flicker may produce an unfavorable influence on the power supply. The large ripple may deteriorate response of the temperature control for the fixing roller.

In view of this circumstance, an objective of this invention is to provide a fixing device and an image forming apparatus capable of supplying low electronic power to the electromagnetic coil with zero cross switching of the switching device.

The present invention solves this subject as follows.

A fixing device according to the first aspect of this invention has:

an electromagnetic coil placed with a gap from a member to be heated, the member being made of a magnetic material;

a switching device that supplies electronic power to the electromagnetic coil;

a switching control unit that controls duty ratio of a switching operation for the switching device under a condition that a load voltage and a load current of the switching device are substantially zero when the switching device is turned on and/or off, (i.e. in terms of zero cross switching);

a shield member capable of being placed between the electromagnetic coil and the member to be heated to shield the member to be heated against a magnetic flux from the electromagnetic coil; and

a shield control unit that controls a shield amount of the shield member by moving either the shield member or both the electromagnetic coil and the member to be heated for changing a distance between the shield member and the electromagnetic coil and a distance between the shield member and the member to be heated.

For example, the member to be heated may be any of a fixing roller, a fixing belt, and a heating roller that is thermally connected to the fixing roller.

This fixing device controls a shield amount against a magnetic flux from the electromagnetic coil to the member to be heated, namely, strength of an electromagnetic coupling between the member to be heated and the electromagnetic coil, by changing a position of the shield member or the electromagnetic coil. The lower the strength of the electromagnetic coupling is, the lower the electronic power supplied to the electromagnetic coil (i.e. energy consumption) is.

Therefore, the strength of the electromagnetic coupling is reduced while duty ratio of a switching operation for the switching device is controlled in a range capable of zero cross switching, and consequently, low electronic power is supplied to the electromagnetic coil. As a result, an electronic power loss, and malfunction due to overheat at the switching device tend not to occur. Further, a ripple due to a switching operation of the switching device tends not to occur, and it results in good response of the temperature control for the fixing roller.

Further, the fixing device according to the first aspect of this invention may have a setting unit that sets a value of electronic power supplied to the electromagnetic coil according to a temperature of either the fixing roller or the fixing belt. This configuration controls a value of electronic power supplied to the electromagnetic coil by controlling a shield amount due to the shield member with the shield control unit while the switching control unit keeps the duty ratio as a predetermined minimum value under the condition, when the setting unit has set the value of the electronic power equal to or less than a predetermined minimum value.

Therefore, the predetermined minimum value of the electronic power is set as a minimum value of the electronic power capable of the zero cross switching at the switching control unit, and even if the setting unit sets the value of the electronic power equal to or less than the minimum value, then the switching control unit performs the zero cross switching, and controls the value of the electronic power supplied to the electromagnetic coil as equal to or less than the minimum value.

An image forming apparatus according to the second aspect of this invention has:

a fixing device that has an electromagnetic coil placed with a gap from a member to be heated, the member being made of a magnetic material;

a switching device that supplies electronic power to the electromagnetic coil;

a switching control unit that controls duty ratio of a switching operation for the switching device under a condition that a load voltage and a load current of the switching device are substantially zero when the switching device is turned on and/or off;

a shield member capable of being placed between the electromagnetic coil and the member to be heated to shield the member to be heated against a magnetic flux from the electromagnetic coil; and

a shield control unit that controls a shield amount of the shield member by moving either the shield member or both the electromagnetic coil and the member to be heated for changing a distance between the shield member and the electromagnetic coil and a distance between the shield member and the member to be heated.

For example, the member to be heated may be any of a fixing roller, a fixing belt, and a heating roller that is thermally connected to the fixing roller.

Further, as well as the fixing device according to the first aspect, the image forming apparatus according to the second aspect of this invention may have a setting unit that sets a value of electronic power supplied to the electromagnetic coil according to a temperature of either the fixing roller or the fixing belt. This configuration controls a value of electronic power supplied to the electromagnetic coil by controlling a shield amount due to the shield member with the shield control unit while the switching control unit keeps the duty ratio as a predetermined minimum value under the condition, when the setting unit has set the value of the electronic power equal to or less than a predetermined minimum value.

A fixing device according to the third aspect of this invention has:

an electromagnetic coil placed with a gap from a member to be heated, the member being made of a magnetic material;

a magnetic core that conducts a magnetic flux from the electromagnetic coil to the member to be heated;

a switching device that supplies electronic power to the electromagnetic coil;

a switching control unit that controls duty ratio of a switching operation for the switching device under a condition that a load voltage and a load current of the switching device are substantially zero when the switching device is turned on and/or off, (i.e. in terms of zero cross switching); and

a distance changing unit that changes either a distance between the electromagnetic coil and the magnetic core or a distance between the member to be heated and the electromagnetic coil and/or a distance between the member to be heated and the magnetic core by moving the electromagnetic coil and/or the magnetic core.

For example, the member to be heated may be any of a fixing roller, a fixing belt, and a heating roller that is thermally connected to the fixing roller.

This fixing device controls an amount of a magnetic flux carried to the member to be heated, by changing a distance between the electromagnetic coil and the magnetic core or by changing a distance between the member to be heated and the electromagnetic coil and/or a distance between the member to be heated and the magnetic core. Therefore, the magnetic flux carried to the electromagnetic coil is lowered by moving the electromagnetic core while duty ratio of a switching operation for the switching device is controlled in a range capable of zero cross switching, and consequently, low electronic power is supplied to the electromagnetic coil. As a result, an electronic power loss, and malfunction due to overheat at the switching device tend not to occur. Further, a ripple due to a switching operation of the switching device tends not to occur, and it results in good response of the temperature control for the fixing roller.

Further, the fixing device according to the third aspect of this invention may have a setting unit that sets a value of electronic power supplied to the electromagnetic coil according to a temperature of either the fixing roller or the fixing belt. This configuration controls a value of electronic power supplied to the electromagnetic coil by controlling at least one of the distances with the distance changing unit while the switching control unit keeps the duty ratio as a predetermined minimum value under the condition, when the setting unit has set the value of the electronic power equal to or less than a predetermined minimum value. Therefore, the predetermined minimum value of the electronic power is set as a minimum value of the electronic power capable of the zero cross switching at the switching control unit, and even if the setting unit sets a value of the electronic power equal to or less than the minimum value, then the switching control unit performs the zero cross switching, and controls a value of the electronic power supplied to the electromagnetic coil as equal to or less than the minimum value.

An image forming apparatus according to the fourth aspect of this invention has:

a fixing device that has (a) an electromagnetic coil placed with a gap from a member to be heated, and (b) a magnetic core that conducts a magnetic flux from the electromagnetic coil to the member to be heated, the member being made of a magnetic material;

a switching device that supplies electronic power to the electromagnetic coil;

a switching control unit that controls duty ratio of a switching operation for the switching device under a condition that a load voltage and a load current of the switching device are substantially zero when the switching device is turned on and/or off; and

a distance changing unit that changes either a distance between the electromagnetic coil and the magnetic core or a distance between the member to be heated and the electromagnetic coil and/or a distance between the member to be heated and the magnetic core by moving the electromagnetic coil and/or the magnetic core.

For example, the member to be heated may be any of a fixing roller, a fixing belt, and a heating roller that is thermally connected to the fixing roller.

Further, as well as the fixing device according to the third aspect, the image forming apparatus according to the fourth aspect of this invention may have a setting unit that sets a value of electronic power supplied to the electromagnetic coil according to a temperature of either the fixing roller or the fixing belt. This configuration controls a value of electronic power supplied to the electromagnetic coil by controlling at least one of the distances with the distance changing unit while the switching control unit keeps the duty ratio as a predetermined minimum value under the condition, when the setting unit has set the value of the electronic power equal to or less than a predetermined minimum value.

These and other objects, features and advantages of the present invention will become more apparent upon reading of the following detailed description along with the accompanied drawings.

### BRIEF DESCRIPTION OF THE DRAWINGS

FIG. 1 shows a block diagram that indicates a schematic configuration of a copy machine according to Embodiment 1 of this invention;

FIGS. 2A and 2B show diagrams that indicate a schematic configuration of a fixing device according to Embodiment 1 of this invention;

FIG. 3 shows a block diagram that indicates a system configuration of the fixing device according to Embodiment 1 of this invention;

FIG. 4 shows a flowchart that indicates an instance of procedures for a heating control process performed by the fixing device in the copy machine according to Embodiment 1 of this invention;

FIGS. 5A and 5B show diagrams that indicate a schematic configuration of a fixing device according to Embodiment 2 of this invention;

FIG. 6 shows a block diagram that indicates a system configuration of the fixing device according to Embodiment 2 of this invention;

FIG. 7 shows a flowchart that indicates an instance of procedures for a heating control process performed by the fixing device in the copy machine according to Embodiment 2 of this invention;

FIG. 8 shows another instance of the fixing device according to Embodiment 2 of this invention; and

FIG. 9 shows a diagram for explaining an instance of operation performed by a switching device.

### DETAILED DESCRIPTION OF THE PREFERRED EMBODIMENT

Hereinafter, embodiments of this invention will be explained with referencing to attached drawings.

### Embodiment 1

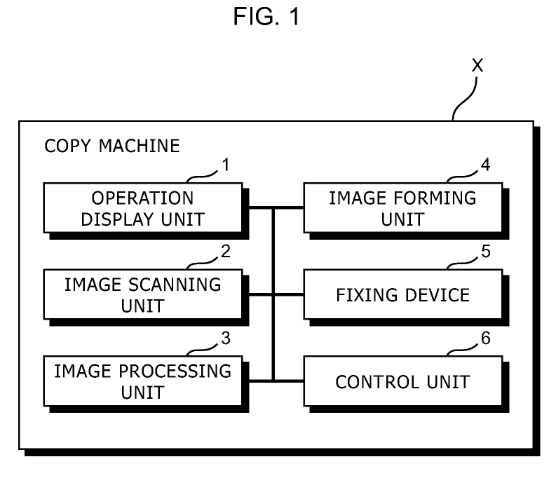

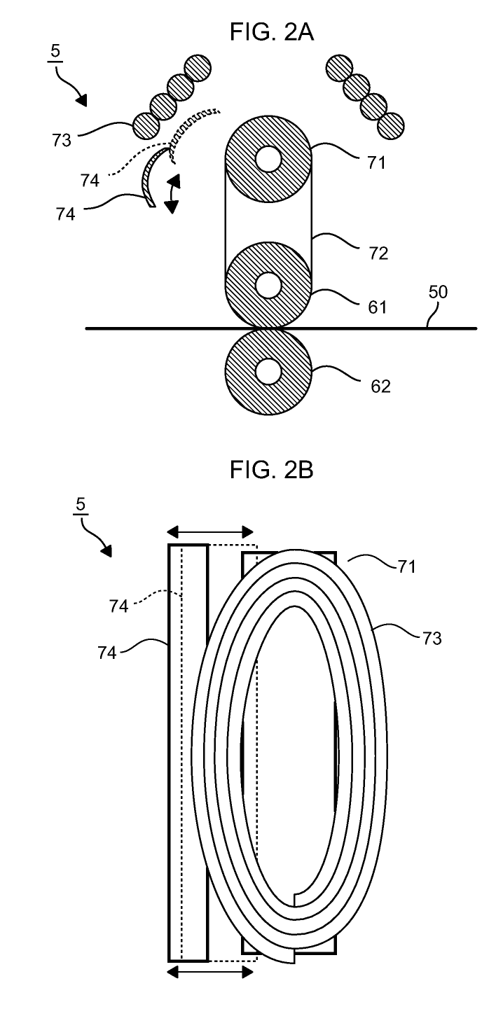

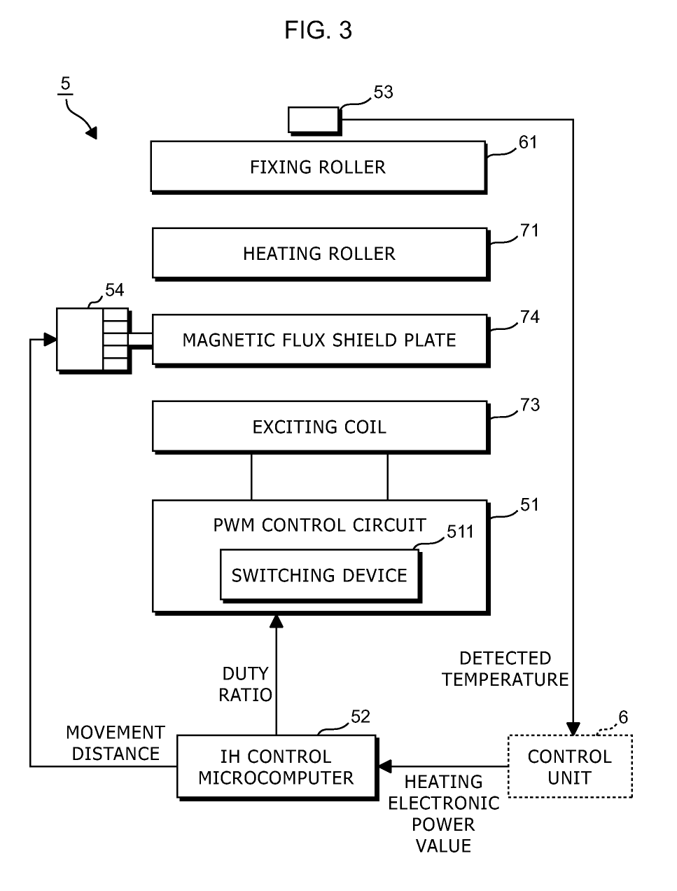

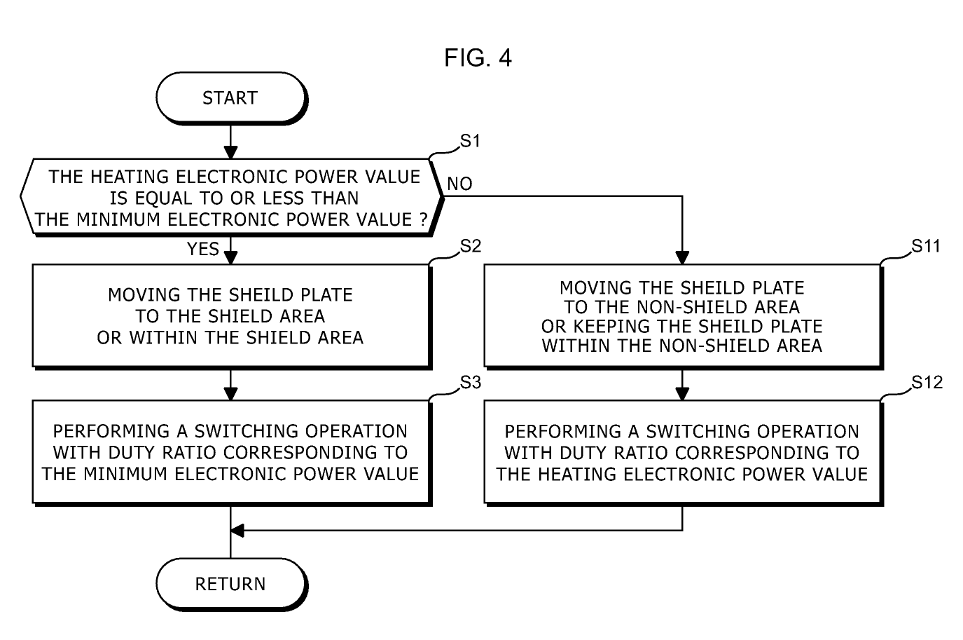

FIG. 1 shows a block diagram that indicates a schematic configuration of a copy machine according to Embodiment 1 of this invention. FIGS. 2A and 2B show diagrams that indicate a schematic configuration of a fixing device according to Embodiment 1 of this invention. FIG. 3 shows a block diagram that indicates a system configuration of the fixing device according to Embodiment 1 of this invention. FIG. 4 shows a flowchart that indicates an instance of procedures for a heating control process performed by the fixing device in the copy machine according to Embodiment 1 of this invention.

A copy machine X in Embodiment 1 is an instance of the image forming apparatus according to this invention, and this invention is also applied to a printer machine, a facsimile machine, a multi function peripheral, or the like.

With referencing to FIG. 1, a schematic configuration of the copy machine X according to Embodiment 1 of this invention is explained as follows. As shown in FIG. 1, the copy machine X has an operation display unit 1, an image scanning unit 2, an image processing unit 3, an image forming unit 4, a fixing device 5, a control unit 6, and so on. The copy machine X also has other components that ordinary copy machine with electrophotographic technology generally has, but for simplicity, these are not explained here.

The control unit 6 has a CPU (Central Processing Unit) and peripherals such as ROM (Read Only Memory) and RAM (Random Access Memory), and executes a program stored in the ROM to control this copy machine X as a whole.

The operation display unit 1 has a display device such as crystal liquid display for displaying various information, and an input device such as touch panel for receiving user input operations in the copy machine X. The image scanning unit 2 is a device that scans an image of a document placed on a document rest or an ADF (Auto Document Feeder), and generates image data. The image data is provided to the image processing unit 3. The image processing unit 3 performs various kinds of image processing for image data such as image data generated from the document by the image scanning unit 2, and document image data provided via a communication network (e.g. LAN) by an information processing device (not shown). After the image processing unit 3 processes the image data, the processed image data is provided to the image forming unit 4. The image forming unit 4 has a photoconductor drum, an electrification device, a developing device, an LSU (Laser Scanning Unit), and so on, and forms a toner image (i.e. a developer image) corresponding to the image data provided from the image processing unit 3, and transfers the toner image onto a sheet.

The fixing device 5 melts and fixes the toner image on the sheet. The copy machine X of Embodiment 1 has a main feature in a configuration of the fixing device 5, and it is next explained in detail.

FIG. 2A shows a schematic cross-sectional view from a side of the fixing device 5. FIG. 2B shows a top view of the fixing device 5. FIG. 3 shows a block diagram that indicates a system configuration of the fixing device 5.

As shown in FIGS. 2A and 2B, the fixing device 5 has a fixing roller 61, a pressure roller 62, a heating roller 71 (an instance of the member to be heated), a fixing belt 72, an exciting coil 73 (an instance of the electromagnetic coil), and a shield plate 74 (an instance of the shield member). After the image forming unit 4 transfers a toner image onto a sheet, the fixing roller 61 and the pressure roller 62 rotate, and they pinch the sheet transferred on a sheet transportation path 50. The heating roller 71 is made of a magnetic material such as iron. The fixing belt 72 is stretched and installed on the outside of the heating roller 71 and the fixing roller 61. The exciting coil 73 is used to heat the heating roller 71 by induction heating. The shield plate 74 is movably supported by a driving mechanism (not shown).

This driving mechanism (not shown) moves the shield plate 74 with a driving force provided from a driving motor 54 (mentioned below, see FIG. 3) in the directions of arrows in FIGS. 2A and 2B. For example, the driving mechanism (not shown) may have an arm to turn the shield plate 74 around an axis, or a pair of rack and pinion to slide the shield plate 74, with driving force provided from the driving motor 54 (see FIG. 3).

The exciting coil 73 is composed of an electronic wire wound on a magnetic core such as iron core, is spaced and fixed apart from the heating roller 71 with a predetermined distance. The exciting coil 73 may be an air core coil. The exciting coil 73 has a length equal to or longer than a length of the heating roller 71 in its longitude direction (i.e. the width direction of the sheet). Pluralities of electromagnetic coils may be placed in line in its longitude direction of the heating roller 71 to compose the exciting coil 73.

The fixing device 5 supplies an AC current to the exciting coil 73 to generate a magnetic flux through the heating roller 71. This magnetic flux generates an induction current (i.e. an eddy current) in the heating roller 71. Hence, the heating roller 71 is heated by induction heating.

The fixing belt 72 is used to thermally connect the fixing roller 61 to the heating roller 71, and heats the fixing roller 61 by transmitting heat from the heating roller 71 to the fixing roller 61. Alternatively, it is possible to use another configuration, in which the heating roller 71 and the fixing belt 72 are not used, and the fixing roller 61 is made of a magnetic material, and the fixing roller 61 is directly heated with induction heating by the exciting coil 73. In this configuration, the fixing roller 61 corresponds to the member to be heated. Further, it is possible to use another configuration, in which the fixing belt 72 is made of a magnetic material, and the fixing belt 72 is heated with induction heating by the exciting coil 73. In this configuration, the fixing belt 72 corresponds to the member to be heated. Further, in this configuration, with heat generated in the fixing belt 72, the fixing device 5 melts and fixes a toner image on a sheet pinched by the fixing roller 61 and the pressure roller 62.

The shield plate 74 is a plate member that has a length equal to or longer than the length of the exciting coil 73 in its longitude direction, namely, equal to or longer than a length of the heating roller 71 in its longitude direction. The shield plate 74 is made of a non-magnetic material such as copper (i.e. anti-magnetic material), and shields the heating roller 71 against a magnetic flux from the exciting coil 73 when the shield plate 74 is placed between the exciting coil 73 and the heating roller 71. A shield amount due to the shield plate 74 depends on a relative position of the shield plate 74 from the exciting coil 73 and the heating roller 71. In other words, a shield amount due to the shield plate 74 depends on how much the shield plate 74 interferes with electromagnetic coupling between the exciting coil 73 and the heating roller 71.

With referencing to FIG. 3, a system configuration of the fixing device 5 is next explained.

As shown in FIG. 3, the fixing device 5 has a PWM control circuit 51, an IH control microcomputer 52, a temperature sensor 53, and a driving motor 54. The PWM control circuit 51 has electronic components such as a switching device 511 (e.g. IGBT) for supplying electronic power to the exciting coil 73. The IH control microcomputer 52 has a control device such as CPU, RAM and ROM. The temperature sensor 53 (e.g. thermistor) detects temperature of the fixing roller 61. The driving motor 54 (e.g. stepping motor) is connected to the driving mechanism (not shown).

The PWM control circuit 51 provides a switching signal to the switching device 511 according to an instruction from the IH control microcomputer 52 to control a switching operation of the switching device 511, and controls power supply to either a voltage resonance circuit or a current resonance circuit that includes the exciting coil 73 and a condenser (not shown) by controlling the switching operation. An inverter circuit that includes the switching device 511, the exciting coil 73, and the condenser (not shown) is similar to ordinary one, and therefore the inverter circuit is not explained here.

The temperature sensor 53 detects temperature of a center part of the fixing roller 61, and provides a detecting result to the control unit 6. The control unit 6 sets a value of electronic power supplied to the exciting coil 73 according to the temperature of the fixing roller 61 detected by the temperature sensor 53 so that temperature of the fixing roller 61 becomes equal to a preset fixing temperature (e.g. 200 degree Celsius). Hereinafter, this value of electronic power set here is called as “heating electronic power value.” For example, information on a relationship between the heating electronic power value and a temperature difference of the fixing temperature and the detected temperature has been stored as a formula or a data table in an internal memory of the control unit 6, and the control unit 6 references the information and sets the heating electronic power value corresponding to the temperature difference. Since the control unit 6 sets the heating electronic power value based on the temperature detected by the temperature sensor 53, it corresponds to the setting unit that sets a value of electronic power to be supplied.

Alternatively, the setting unit may be embodied by the IH control microcomputer 52, that is, the IH control microcomputer 52 may set the heating electronic power value corresponding to the temperature of the fixing roller 61 detected by the temperature sensor 53. If the control unit 6 sets the heating electronic power value, then the heating electronic power value is provided to the IH control microcomputer 52.

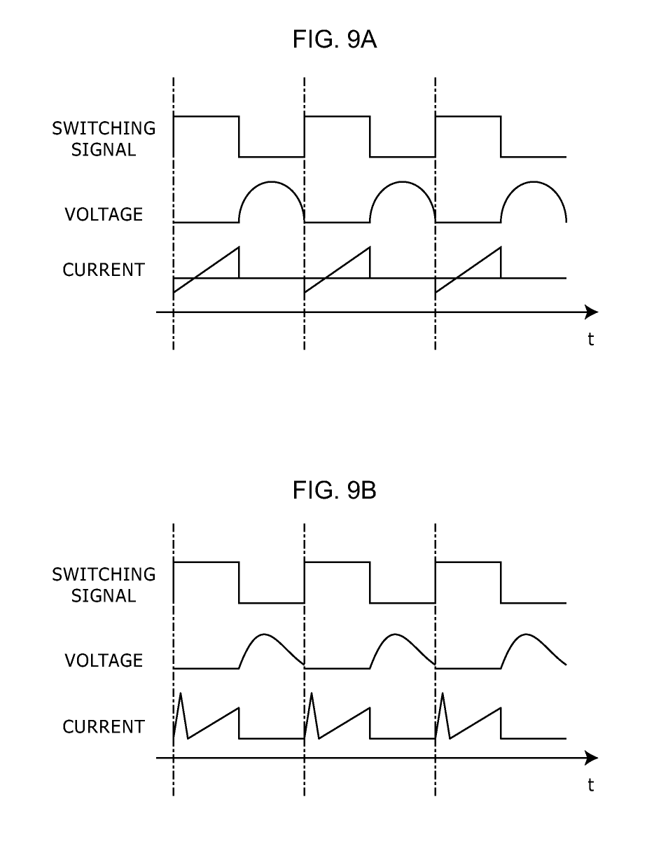

The IH control microcomputer 52 sets duty ratio of a switching operation for the switching device 511 in the PWM control circuit 51 according to the heating electronic power value provided from the control unit 6. The IH control microcomputer 52 sets the duty ratio as a value capable of zero cross switching, that is, capable of turning on and off the switching device 511 at a timing when a load voltage and a load current of the switching device 511 are substantially zero (see FIG. 9A). Since the IH control microcomputer 52 performs such control, it corresponds to the switching control unit. Alternatively, the switching control unit may be embodied by the PWM control circuit 51. If the IH control microcomputer 52 sets the duty ratio, then the duty ratio is provided to the PWM control circuit 51. The PWM control circuit 51 performs switching control of the switching device 511 according to the duty ratio set by the IH control microcomputer 52.

As shown FIG. 9B, if the heating electronic power value becomes too small, and the duty ratio of a switching operation for the switching device 511 becomes too low (i.e. the turned-on period is too short), then the zero cross switching (see FIG. 9A) can not be performed only by the PWM control circuit 51. If the zero cross switching were not performed, then an electronic power loss would occur due to a switching operation.

In the copy machine X of Embodiment 1, the IH control microcomputer 52 of the fixing device 5 performs a heating control process mentioned below (see a flowchart in FIG. 4), in which it controls not only the duty ratio of the switching device 511 but also an amount of magnetic flux shield due to the shield plate 74 to control a value of electronic power supplied to the exciting coil 73 when the heating electronic power value is so small that the zero cross switching can not be performed only by the PWM control circuit 51. Hereinafter, in the fixing device 5, a minimum heating electronic power value under a condition capable of the zero cross switching for the switching device 511 is called as “minimum electronic power value”, and the duty ratio corresponding to the minimum electronic power value is called as “minimum duty ratio.” The minimum electronic power value and the minimum duty ratio are given by performing an experiment or a simulation in advance.

With referencing to a flowchart in FIG. 4, here is explained an instance of the heating control process performed by the fixing device 5 in the copy machine X. Here, S1, S2, . . . in FIG. 4 are numbers to identify steps in the process.

The heating control process is performed by the IH control microcomputer 52 to heat the fixing roller 61 in the fixing device 5 by induction heating, for example, when the copy machine X performs image forming or stands by. If one control unit is composed of the IH control microcomputer 52 and the control unit 6, then this control unit performs the heating control process.

At first, in Step S1, the IH control microcomputer 52 determines whether or not the heating electronic power value set by the control unit 6 is equal to or less than the preset minimum electronic power value. In other words, here is determined whether or not the heating electronic power value is capable of zero cross switching, if electronic power at the heating electronic power value is supplied only by the switching device 511.

If it is determined that the heating electronic power value is equal to or less than the minimum electronic power value (YES at Step S1), then Step S2 is next executed. If it is determined that the heating electronic power value is greater than the minimum electronic power value (NO at Step S1), then Step S11 is next executed.

### (Steps S11 and S12)

At first, here is explained the case that it is determined that the heating electronic power value is greater than the minimum electronic power value (NO at Step S1) and Step S11 is chosen.

In Step S11, the IH control microcomputer 52 controls the driving motor 54, so that the driving motor 54 moves the shield plate 74 to a position in an area where the shield plate 74 does not lower a magnetic flux from the exciting coil 73 to the heating roller 71 (for example, a position of the shield plate 74 depicted with a solid line in FIGS. 2A and 2B; hereinafter this area is called as “non-shield area”). If the shield plate 74 has been in the non-shield area, then the shield plate 74 is kept at the current position. The position of the shield plate 74 may be identified with a detecting result of a position detecting sensor (not shown) such as limit switch, a driving history of the driving motor 54, or the like.

Next to Step S11, in Step S12, the IH control microcomputer 52 sets duty ratio of a switching operation for the switching device 511 according to the heating electronic power value, and provides this duty ratio to the PWM control circuit 51. Therefore, the PWM control circuit 51 controls the switching operation of the switching device 511 according to the duty ratio instructed by the IH control microcomputer 52, so that electronic power is supplied at the heating electronic power value. In this case, the heating electronic power value is greater than the minimum electronic power value, and the duty ratio of the switching operation for the switching device 511 is greater than the minimum duty ratio, and therefore the switching device 511 performs zero cross switching. Consequently, an electronic power loss at the switching device 511 does not occur.

### (Step S2)

Next is explained the case that it is determined that the heating electronic power value is equal to or less than the minimum electronic power value (YES at Step S1) and Step S2 is chosen.

In Step S2, the IH control microcomputer 52 controls the driving motor 54, so that the driving motor 54 moves the shield plate 74 to a position in an area where the shield plate 74 lowers a magnetic flux from the exciting coil 73 to the heating roller 71 (for example, a position of the shield plate 74 depicted with a dashed line in FIGS. 2A and 2B; hereinafter this area is called as “shield area”). The IH control microcomputer 52 controls a movement distance of the shield plate 74 according to the heating electronic power value to control a relative position of the shield plate 74 from the exciting coil 73 and the heating roller 71, and to control an amount of magnetic flux shield due to the shield plate 74. Since the IH control microcomputer 52 performs the aforementioned control, it corresponds to the shield control unit.

Specifically, while the switching device 511 of the PWM control circuit 51 performs a switching operation at the minimum duty ratio, the IH control microcomputer 52 moves the shield plate 74 to a position for supplying electronic power to the exciting coil 73 at the heating electronic power value. For example, information on a relationship between the heating electronic power value and a position of the shield plate 74 has been stored as a formula or a data table in an internal memory of the IH control microcomputer 52, and IH control microcomputer 52 references the information and sets the movement distance of the shield plate 74 corresponding to the heating electronic power value. As mentioned above, the position of the shield plate 74 may be identified with a detecting result of a position detecting sensor (not shown) such as limit switch, a driving history of the driving motor 54, or the like.

### (Step S3)

After the shield plate 74 is moved, in Step S3, the IH control microcomputer 52 provides duty ratio to the PWM control circuit 51, and this duty ratio is the minimum duty ratio corresponding to the minimum electronic power value. The PWM control circuit 51 drives the switching device 511 to perform a switching operation at the minimum duty ratio instructed by the IH control microcomputer 52.

As mentioned, if a value of electronic power supplied to the exciting coil 73 (i.e. heating electronic power value) is set as equal to or less than the minimum electronic power value, then the IH control microcomputer 52 keeps duty ratio of a switching operation for the switching device 511 as the minimum duty ratio, and controls an amount of magnetic flux shield due to the shield plate 74 to supply electronic power to the exciting coil 73 at the heating electronic power value. Since the IH control microcomputer performs the aforementioned control, it corresponds to the electronic power control unit.

As mentioned above, the fixing device 5 can lower a magnetic flux from the exciting coil 73 to the heating roller 71 by the shield plate 74, and therefore it is possible to supply electronic power to the exciting coil 73 at an electronic power value equal to or less than the minimum electronic power value while zero cross switching is performed for a switching operation of the switching device 511 (see FIG. 9A). As a result, an electronic power loss due to switching of the switching device 511, and malfunction due to overheat at the switching device 511 tend not to occur.

In Embodiment 1, the shield plate 74 is only placed between the exciting coil 73 and one side of the heating roller 71 (e.g. the left side of the heating roller 7 in FIG. 2A). In addition to this, another shield plate may also be placed between the exciting coil 73 and the opposite side of the heating roller 71 (e.g. the right side of the heating roller 71 in FIG. 2A) to lower a magnetic flux from the exciting coil 73 to the heating roller 71 in both sides of the heating roller 71.

Further, in Embodiment 1, instead of moving the shield plate 74 to change the shield amount, it is possible to use another configuration capable of changing a relative position of the shield plate 74 from the exciting coil 73 and the heating roller 71, for example, a configuration to move the exciting coil 73 and the heating roller 71.

### Embodiment 2

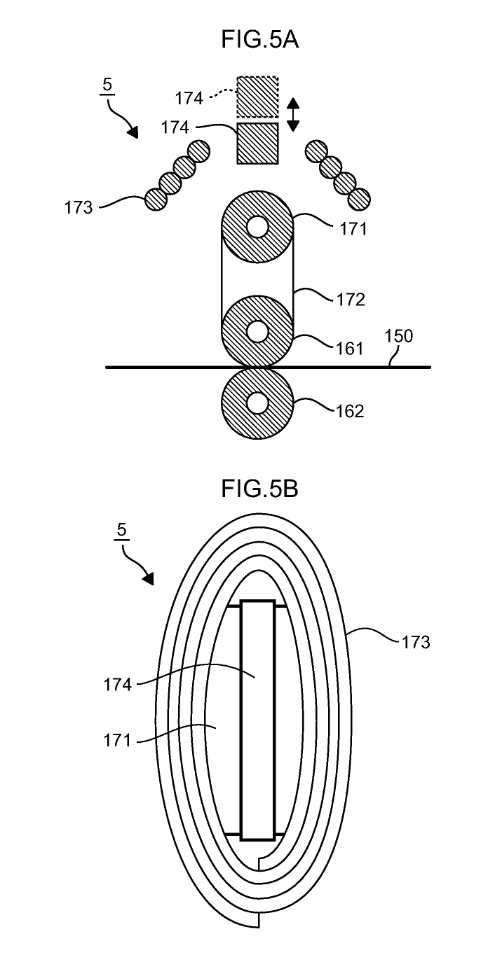

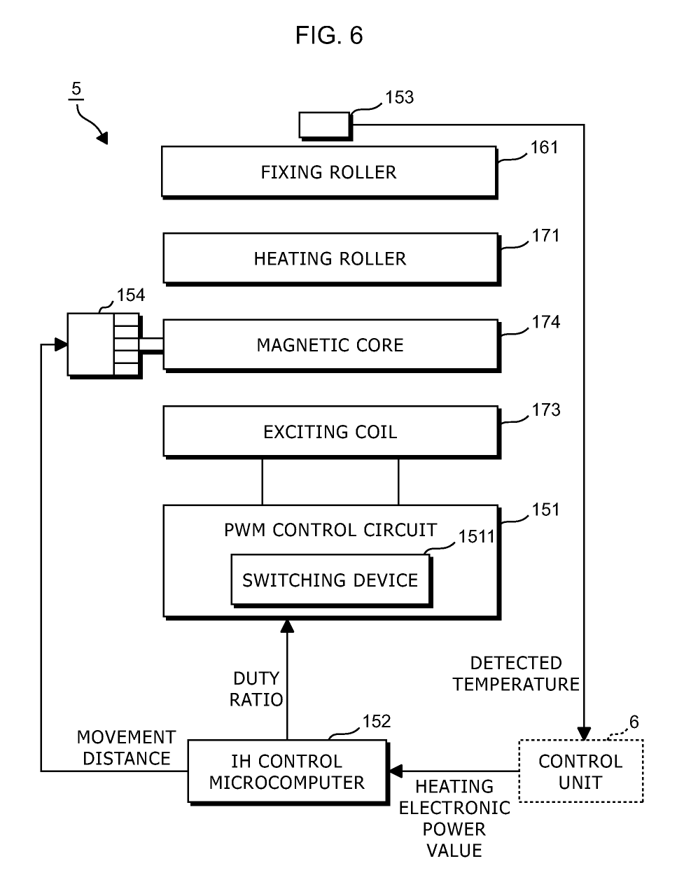

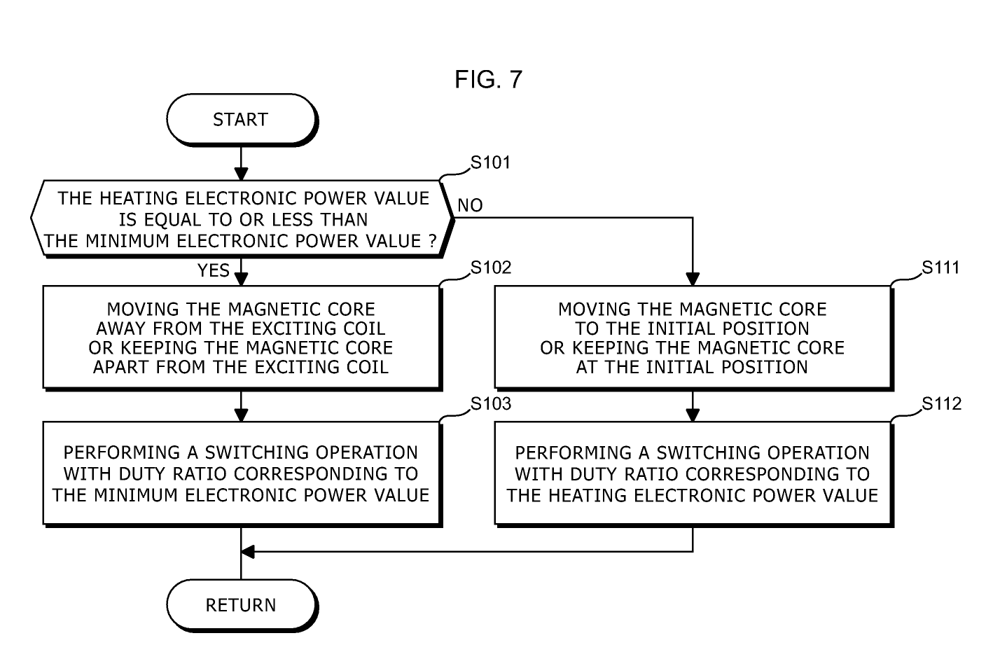

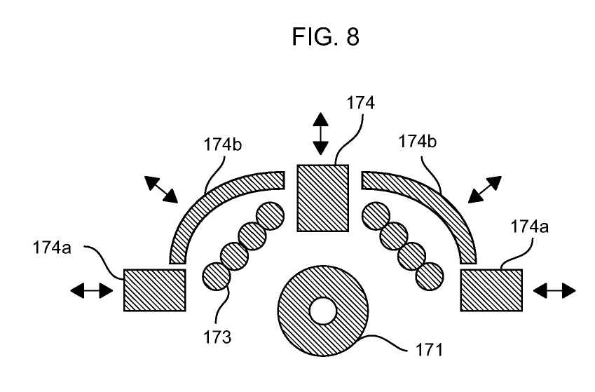

FIGS. 5A and 5B show diagrams that indicate a schematic configuration of a fixing device according to Embodiment 2 of this invention. FIG. 6 shows a block diagram that indicates a system configuration of the fixing device according to Embodiment 2 of this invention. FIG. 7 shows a flowchart that indicates an instance of procedures for a heating control process performed by the fixing device in the copy machine according to Embodiment 2 of this invention. FIG. 8 shows another instance of the fixing device according to Embodiment 2 of this invention.

A copy machine X in Embodiment 2 is an instance of the image forming apparatus according to this invention, and this invention is also applied to a printer machine, a facsimile machine, a multi function peripheral, or the like.

A schematic configuration of the copy machine X in Embodiment 2 is identical to that in Embodiment 1, and therefore it is not explained here.

The copy machine X of Embodiment 2 has a main feature in a configuration of the fixing device 5, and it is next explained in detail.

FIG. 5A shows a schematic cross-sectional view from a side of the fixing device 5 in Embodiment 2. FIG. 5B shows a top view of the fixing device 5 in Embodiment 2. FIG. 6 shows a block diagram that indicates a system configuration of the fixing device 5 in Embodiment 2.

As shown in FIGS. 5A and 5B, the fixing device 5 has a fixing roller 161, a pressure roller 162, a heating roller 171 (an instance of the member to be heated), a fixing belt 172, an exciting coil 173 (an instance of the electromagnetic coil), and a magnetic core 174. After the image forming unit 4 transfers a toner image onto a sheet, the fixing roller 161 and the pressure roller 162 rotate, and they pinch the sheet transferred on a sheet transportation path 150. The heating roller 171 is made of a magnetic material such as iron. The fixing belt 172 is stretched and installed on the outside of the heating roller 171 and the fixing roller 161. The exciting coil 173 is used to heat the heating roller 171 by induction heating. The magnetic core 174 is movably supported by a driving mechanism (not shown).

This driving mechanism (not shown) moves the magnetic core 174 with a driving force provided from a driving motor 154 (mentioned below, see FIG. 6) in the directions of arrows in FIG. 5A. For example, the driving mechanism (not shown) may have an arm to turn the magnetic core 174 around an axis, or a pair of rack and pinion to slide the magnetic core 174, with driving force provided from the driving motor 154 (see FIG. 6).

The exciting coil 173 is composed of an electronic wire wound around an air core, is spaced and fixed apart from the heating roller 171 with a predetermined distance. The exciting coil 173 has a length equal to or longer than the length of the heating roller 171 in its longitude direction (i.e. the width direction of the sheet). Pluralities of electromagnetic coils may be placed in line in its longitude direction of the heating roller 171 to compose the exciting coil 173. The fixing device 5 supplies an AC current to the exciting coil 173 to generate a magnetic flux through the heating roller 171. This magnetic flux generates an induction current (i.e. an eddy current) in the heating roller 171. Hence, the heating roller 171 is heated by induction heating.

The fixing belt 172 is used to thermally connect the fixing roller 161 to the heating roller 171, and heats the fixing roller 161 by transmitting heat from the heating roller 171 to the fixing roller 161. Alternatively, it is possible to use another configuration, in which the heating roller 171 and the fixing belt 172 are not used, and the fixing roller 161 is made of a magnetic material, and the fixing roller 161 is directly heated with induction heating by the exciting coil 173. In this configuration, the fixing roller 161 corresponds to the member to be heated. Further, it is possible to use another configuration, in which the fixing belt 172 is made of a magnetic material, and the fixing belt 172 is heated with induction heating by the exciting coil 173. In this configuration, the fixing belt 172 corresponds to the member to be heated. Further, in this configuration, with heat generated in the fixing belt 172, the fixing device 5 melts and fixes a toner image on a sheet pinched by the fixing roller 161 and the pressure roller 162.

On the other hand, the magnetic core 174 is placed in the center area of the exciting coil 173, and has a width equal to or greater than the length of the heating roller in its longitude direction. The magnetic core 174 is made of a magnetic material such as iron or ferrite, and conducts a magnetic flux from the electromagnetic coil 173 to the heating roller 171. An amount of the magnetic flux conducted by the magnetic core 174 depends on a distance between the magnetic core 174 and the exciting coil 173, and a distance between the magnetic core 174 and the heating roller 171. Specifically, the shorter the distance between the magnetic core 174 and the exciting core 173 is, the larger the amount of the magnetic flux conducted by the magnetic core 174 from the exciting coil 173 to the heating roller 171 is.

With referencing to FIG. 6, a system configuration of the fixing device 5 is next explained.

As shown in FIG. 6, the fixing device 5 has a PWM control circuit 151, an IH control microcomputer 152, a temperature sensor 153, and a driving motor 154. The PWM control circuit 151 has electronic components such as a switching device 1511 (e.g. IGBT) for supplying electronic power to the exciting coil 173. The IH control microcomputer 152 has a control device such as CPU, RAM and ROM. The temperature sensor 153 (e.g. thermistor) detects temperature of the fixing roller 161. The driving motor 154 (e.g. stepping motor) is connected to the driving mechanism (not shown).

The PWM control circuit 151 provides a switching signal to the switching device 1511 according to an instruction from the IH control microcomputer 152 to control a switching operation of the switching device 1511, and controls power supply to either a voltage resonance circuit or a current resonance circuit that includes the exciting coil 173 and a condenser (not shown) by controlling the switching operation. An inverter circuit that includes the switching device 1511, the exciting coil 173, and the condenser (not shown) is similar to ordinary one, and therefore the inverter circuit is not explained here.

The temperature sensor 153 detects temperature of a center part of the fixing roller 161, and provides a detecting result to the control unit 6. The control unit 6 sets a value of electronic power supplied to the exciting coil 173 according to the temperature of the fixing roller 161 detected by the temperature sensor 153 so that temperature of the fixing roller 161 becomes a preset fixing temperature (e.g. 200 degree Celsius). Hereinafter, the value of electronic power set here is called as “heating electronic power value.” For example, information on a relationship between the heating electronic power value and a temperature difference of the fixing temperature and the detected temperature has been stored as a formula or a data table in an internal memory of the control unit 6, and the control unit 6 references the information and sets the heating electronic power value corresponding to the temperature difference.

Since the control unit 6 sets the heating electronic power value based on the temperature detected by the temperature sensor 153, it corresponds to the setting unit that sets a value of electronic power to be supplied. Alternatively, the setting unit may be embodied by the IH control microcomputer 152, that is, the IH control microcomputer 152 may set the heating electronic power value based on the temperature of the fixing roller 161 detected by the temperature sensor 153. If the control unit 6 sets the heating electronic power value, then the heating electronic power value is provided to the IH control microcomputer 152.

The IH control microcomputer 152 sets duty ratio of a switching operation for the switching device 1511 in the PWM control circuit 151 according to the heating electronic power value provided from the control unit 6. The IH control microcomputer 152 sets the duty ratio as a value capable of zero cross switching, that is, capable of turning on and off the switching device 1511 when a load voltage and a load current of the switching device 1511 are substantially zero (see FIG. 9A). Since the IH control microcomputer 152 performs such control, it corresponds to the switching control unit.

Alternatively, the switching control unit may be embodied by the PWM control circuit 151.

If the IH control microcomputer 152 sets the duty ratio, then the duty ratio is provided to the PWM control circuit 151. The PWM control circuit 151 performs switching control of the switching device 1511 according to the duty ratio set by the IH control microcomputer 152.

As shown FIG. 9B, if the heating electronic power value becomes too small, and the duty ratio of a switching operation for the switching device 1511 becomes too low (i.e. the turned-on period is too short), then the zero cross switching (see FIG. 9A) can not be performed only by the PWM control circuit 151. If the zero cross switching were not performed, then an electronic power loss would occur due to a switching operation.

In the copy machine X of Embodiment 2, the IH control microcomputer 152 of the fixing device 5 performs a heating control process mentioned below (see a flowchart in FIG. 7), in which it controls not only the duty ratio of the switching device 1511 but also an amount of a magnetic flux conducted by the magnetic core 174 to control a value of electronic power supplied to the exciting coil 173 when the heating electronic power value is so small that the zero cross switching can not be performed only by the PWM control circuit 151. Hereinafter, in the fixing device 5, a minimum heating electronic power value under a condition capable of the zero cross switching for the switching device 1511 is called as “minimum electronic power value”, and the duty ratio corresponding to the minimum electronic power value is called as “minimum duty ratio.” The minimum electronic power value and the minimum duty ratio are given by performing an experiment or a simulation in advance.

With referencing to a flowchart in FIG. 7, here is explained an instance of the heating control process performed by the fixing device 5 in the copy machine X. Here, S101, S102, . . . in FIG. 7 are numbers to identify steps in the process.

The heating control process is performed by the IH control microcomputer 152 to heat the fixing roller 161 in the fixing device 5 by induction heating, for example, when the copy machine X performs image forming or stands by. If one control unit is composed of the IH control microcomputer 152 and the control unit 6, then this control unit performs the heating control process.

At first, in Step S101, the IH control microcomputer 152 determines whether or not the heating electronic power value set by the control unit 6 is equal to or less than the preset minimum electronic power value. In other words, here is determined whether or not the heating electronic power value is capable of zero cross switching, if electronic power at the heating electronic power value is supplied only by the switching device 1511.

If it is determined that the heating electronic power value is equal to or less than the minimum electronic power value (YES at Step S101), then Step S102 is next executed. If it is determined that the heating electronic power value is greater than the minimum electronic power value (NO at Step S101), then Step S111 is next executed.

### (Steps S111 and S112)

At first, here is explained the case that it is determined that the heating electronic power value is greater than the minimum electronic power value (NO at Step S101) and Step S111 is chosen.

In Step S111, the IH control microcomputer 152 controls the driving motor 154, so that the driving motor 154 moves the magnetic core 174 to an initial position (for example, a position of the magnetic core 174 depicted with a solid line in FIG. 5A). If the magnetic core 174 has been at the initial position, then the magnetic core 174 is kept at the current position. This initial position is a position where the magnetic flux from the exciting coil 173 to the heating roller 171 becomes maximum, and is decided according to a result of an experiment, a simulation, or the like in advance. The position of the magnetic core 174 may be identified with a detecting result of a position detecting sensor (not shown) such as limit switch, a driving history of the driving motor 154, or the like.

Next to Step S111, in Step S112, the IH control microcomputer 152 sets duty ratio of a switching operation for the switching device 1511 according to the heating electronic power value, and provides this duty ratio to the PWM control circuit 151. Therefore, the PWM control circuit 151 controls the switching operation of the switching device 1511 according to the duty ratio instructed by the IH control microcomputer 152, so that electronic power is supplied at the heating electronic power value. In this case, the heating electronic power value is greater than the minimum electronic power value, and the duty ratio of the switching operation for the switching device 1511 is greater than the minimum duty ratio, and therefore the switching device 1511 performs zero cross switching. Consequently, an electronic power loss at the switching device 1511 does not occur.

### (Step S102)

Next is explained the case that it is determined that the heating electronic power value is equal to or less than the minimum electronic power value (YES at Step S101) and Step S102 is chosen.

In Step S102, the IH control microcomputer 152 controls the driving motor 154, so that the driving motor 154 moves the magnetic core 174 away from the exciting coil 173 and the heating roller 171 (for example, to a position of the magnetic core 174 depicted with a dashed line in FIG. 5A).

The IH control microcomputer 152 controls a movement distance of the magnetic core 174 according to the heating electronic power value to control a distance between the magnetic core 174 and the exciting coil 173 and/or a distance between the magnetic core 174 and the heating roller 171, and to control an amount of a magnetic flux conducted by the magnetic core 174 from the exciting coil to the heating roller 171. Since the IH control microcomputer 152 performs the aforementioned control, it corresponds to the distance changing unit.

Specifically, while the switching device 1511 of the PWM control circuit 151 performs a switching operation at the minimum duty ratio, the IH control microcomputer 152 moves the magnetic core 174 to a position for supplying electronic power to the exciting coil 173 at the heating electronic power value. For example, information on a relationship between the heating electronic power value and a position of the magnetic core 174 has been stored as a formula or a data table in an internal memory of the IH control microcomputer 152, and IH control microcomputer 152 references the information and sets the movement distance of the magnetic core 174 corresponding to the heating electronic power value. As mentioned above, the position of the magnetic core 174 may be identified with a detecting result of a position detecting sensor (not shown) such as limit switch, a driving history of the driving motor 154, or the like.

### (Step S103)

After the magnetic core 174 is moved, in Step S103, the IH control microcomputer 152 provides duty ratio to the PWM control circuit 151, and this duty ratio is the minimum duty ratio corresponding to the minimum electronic power value. The PWM control circuit 151 drives the switching device 1511 to perform a switching operation at the minimum duty ratio instructed by the IH control microcomputer 152.

As mentioned, if a value of electronic power supplied to the exciting coil 173 (i.e. heating electronic power value) is set as equal to or less than the minimum electronic power value, then the IH control microcomputer 152 keeps duty ratio of a switching operation for the switching device 1511 as the minimum duty ratio, and changes a distance between the magnetic core 174 and the exciting coil 173 and/or a distance between the magnetic core 174 and the heating roller 171 to supply electronic power to the exciting coil 173 at the heating electronic power value. Since the IH control microcomputer 152 performs the aforementioned control, it corresponds to the electronic power control unit.

As mentioned above, the fixing device 5 can lower a magnetic flux from the exciting coil 173 to the heating roller 171 by moving away the magnetic core 174, and therefore it is possible to supply electronic power to the exciting coil 173 at an electronic power value equal to or less than the minimum electronic power value while zero cross switching is performed for a switching operation of the switching device 1511 (see FIG. 9A). As a result, an electronic power loss due to switching of the switching device 1511, and malfunction due to overheat at the switching device 1511 tend not to occur.

It should be noted that the magnetic core 174 may have another shape, and may be placed at another position than that shown in Embodiment 2.

For example, as shown in FIG. 8, in addition to the magnetic core 174, magnetic cores 174a and 174b may be movably placed in a periphery of the exciting coil 173. In this configuration, the magnetic cores 174, 174a and 174b may be linked as one, and the magnetic cores 174a and 174b are moved together with the magnetic core 174. Alternatively, respective ones of the magnetic cores 174, 174a and 174b may be independently moved in directions of arrows shown in FIG. 8. In the configuration that respective ones of the magnetic cores 174, 174a and 174b may be independently moved, an amount of a magnetic flux from the exciting coil 173 to the heating roller 171 can be controlled more accurately.

### Embodiment 3

In Embodiment 2, the magnetic core 174 is moved, but in Embodiment 3, the fixing device has a configuration to move the exciting coil 173. This configuration is explained here.

In Embodiment 3, the fixing device 5 moves the exciting coil 173 away from the magnetic core 174 and/or the heating roller 171 to change strength of electromagnetic coupling between the exciting coil 173 and the magnetic core 174, and/or strength of electromagnetic coupling between the exciting coil 173 and the heating roller 171 in order to control an amount of a magnetic flux conducted from the exciting coil 173 to the heating roller 171.

For example, the driving mechanism supports the exciting coil 173 instead of the magnetic core 174; and in a heating control process performed by the IH control microcomputer 152, if the heating electronic power value is set as equal to or less than the minimum electronic power value, then the IH control microcomputer 152 keeps duty ratio of a switching operation for the switching device 1511 as the minimum duty ratio, and moves the exciting coil 173 to change a distance between the exciting coil 173 and the heating roller 171 and/or a distance between the exciting coil 173 and the magnetic core 174 in order to reduce an amount of a magnetic flux conducted from the exciting coil 173 to the heating roller 171. Since the IH control microcomputer 152 performs the aforementioned control, it corresponds to the distance changing unit and the electronic power control unit.

This configuration also reduces an electronic power loss due to switching of the switching device 1511, and malfunction due to overheat at the switching device 1511.

Further, it is possible to use another configuration that both the exciting coil 173 and the magnetic core 174 (or the magnetic cores 174, 174a and 174b) are moved away from the heating roller 171. For instance, the exciting core 173 is made by winding an electronic wire around the magnetic core 174 (or each of the magnetic cores 174, 174a and 174b), and then the both the exciting core 173 and the magnetic core 174 (or the magnetic cores 174, 174a and 174b) can be moved together at the same time.

The description of the present invention has been presented for purposes of illustration and description, and is not intended to be exhaustive or limited to the invention in the form disclosed. Many modifications and variations will be apparent to those of ordinary skill in the art.

What is claimed is:

1. A fixing device, comprising:
an electromagnetic coil placed with a gap from a member to be heated, the member being made of a magnetic material;
a switching device that supplies electronic power to the electromagnetic coil;
a switching control unit that controls duty ratio of a switching operation for the switching device under a condition that a load voltage and a load current of the switching device are substantially zero when the switching device is turned on and/or off;
a shield member capable of being placed between the electromagnetic coil and the member to be heated to shield the member to be heated against a magnetic flux from the electromagnetic coil; and
a shield control unit that controls a shield amount of the shield member by moving either the shield member or both the electromagnetic coil and the member to be heated for changing a distance between the shield member and the electromagnetic coil and a distance between the shield member and the member to be heated.

2. The fixing device according to claim 1, wherein:
the member to be heated is any of a fixing roller, a fixing belt, and a heating roller that is thermally connected to the fixing roller.

3. The fixing device according to claim 2, further comprising:
a setting unit that sets a value of electronic power supplied to the electromagnetic coil according to a temperature of either the fixing roller or the fixing belt; and
an electronic power control unit that controls a shield amount due to the shield member by the shield control unit while the switching control unit keeps the duty ratio as a predetermined minimum value under the condition, to control the value of electronic power supplied to the electromagnetic coil, if the setting unit has set the value of the electronic power equal to or less than a predetermined minimum value.

4. An image forming apparatus, comprising:
a fixing device that has an electromagnetic coil placed with a gap from a member to be heated, the member being made of a magnetic material;
a switching device that supplies electronic power to the electromagnetic coil;
a switching control unit that controls duty ratio of a switching operation for the switching device under a condition that a load voltage and a load current of the switching device are substantially zero when the switching device is turned on and/or off;
a shield member capable of being placed between the electromagnetic coil and the member to be heated to shield the member to be heated against a magnetic flux from the electromagnetic coil; and
a shield control unit that controls a shield amount of the shield member by moving either the shield member or both the electromagnetic coil and the member to be heated for changing a distance between the shield member and the electromagnetic coil and a distance between the shield member and the member to be heated.

5. The image forming apparatus according to claim 4, wherein:
the member to be heated is any of a fixing roller, a fixing belt, and a heating roller that is thermally connected to the fixing roller.

6. The image forming apparatus according to claim 5, further comprising:
a setting unit that sets a value of electronic power supplied to the electromagnetic coil according to a temperature of either the fixing roller or the fixing belt; and
an electronic power control unit that controls a shield amount due to the shield member by the shield control unit while the switching control unit keeps the duty ratio as a predetermined minimum value under the condition, to control the value of electronic power supplied to the electromagnetic coil, if the setting unit has set the value of the electronic power equal to or less than a predetermined minimum value.

7. A fixing device, comprising:
an electromagnetic coil placed with a gap from a member to be heated, the member being made of a magnetic material;
a magnetic core that conducts a magnetic flux from the electromagnetic coil to the member to be heated;
a switching device that supplies electronic power to the electromagnetic coil;
a switching control unit that controls duty ratio of a switching operation for the switching device under a condition that a load voltage and a load current of the switching device are substantially zero when the switching device is turned on and/or off; and
a distance changing unit that changes either a distance between the electromagnetic coil and the magnetic core or a distance between the member to be heated and the electromagnetic coil and/or a distance between the member to be heated and the magnetic core by moving the electromagnetic coil and/or the magnetic core.

8. The fixing device according to claim 7, wherein:
the member to be heated is any of a fixing roller, a fixing belt, and a heating roller that is thermally connected to the fixing roller.

9. The fixing device according to claim 8, further comprising:
a setting unit that sets a value of electronic power supplied to the electromagnetic coil according to a temperature of either the fixing roller or the fixing belt; and
an electronic power control unit that causes the distance changing unit to change at least one of the distances while the switching control unit keeps the duty ratio as a predetermined minimum value under the condition, to control the value of electronic power supplied to the electromagnetic coil, if the setting unit has set the value of the electronic power equal to or less than a predetermined minimum value.

10. An image forming apparatus, comprising:
a fixing device that has (a) an electromagnetic coil placed with a gap from a member to be heated, and (b) a magnetic core that conducts a magnetic flux from the electromagnetic coil to the member to be heated, the member being made of a magnetic material;
a switching device that supplies electronic power to the electromagnetic coil;
a switching control unit that controls duty ratio of a switching operation for the switching device under a condition that a load voltage and a load current of the switching device are substantially zero when the switching device is turned on and/or off; and
a distance changing unit that changes either a distance between the electromagnetic coil and the magnetic core or a distance between the member to be heated and the electromagnetic coil and/or a distance between the member to be heated and the magnetic core by moving the electromagnetic coil and/or the magnetic core.

11. The image forming apparatus according to claim 10, wherein:
the member to be heated is any of a fixing roller, a fixing belt, and a heating roller that is thermally connected to the fixing roller.

12. The image forming apparatus according to claim 11, further comprising:
a setting unit that sets a value of electronic power supplied to the electromagnetic coil according to a temperature of either the fixing roller or the fixing belt; and
an electronic power control unit that causes the distance changing unit to change at least one of the distances while the switching control unit keeps the duty ratio as a predetermined minimum value under the condition, to control the value of electronic power supplied to the electromagnetic coil, if the setting unit has set the value of the electronic power equal to or less than a predetermined minimum value.
